(19) United States
(12) Patent Application Publication
(10) Pub. No.: US 2003/0147041 A1
(43) Pub. Date: Aug. 7, 2003

(54) Method of fabricating liquid crystal display apparatus integrated with film type touch panel

(75) Inventors: Eui Yeol Oh, Kyounggi-do (KR); Yong Ik Bang, Daegu (KR); Tae Ho You, Incheon (KR)

Correspondence Address: MORGAN LEWIS & BOCKIUS LLP, 1111 PENNSYLVANIA AVENUE NW, WASHINGTON, DC, 20004, US

(73) Assignee: LG.PHILIPS LCD CO., LTD

(21) Appl. No.: 10/328,169

(22) Filed: Dec. 26, 2002

(30) Foreign Application Priority Data
Dec. 27, 2001 (KR) P2001-85974

(51) Int. Cl. G02F 1/1335

(52) U.S. Cl. 349/187; 349/12

(57) ABSTRACT

A method of fabricating a film type touch panel integrated liquid crystal display apparatus includes the steps of forming a liquid crystal display panel that includes gate lines, data lines, and a plurality of liquid crystal cells; cleaning the liquid crystal display panel; attaching a polarizer integrated touch panel to the cleaned liquid crystal display panel, the polarizer integrated touch panel being configured to generate an electrical signal in response to a pressure applied at a portion of the touch panel by an external force; completing a liquid crystal display module by a TAB process in which the liquid crystal display panel is electrically connected to a printed circuit board (PCB) that is configured to apply a driving signal to the liquid crystal display panel; and assembling the liquid crystal display module with a backlight unit.

This application claims the benefit of Korean Application No. P2001-85974, filed on Dec. 27, 2001 in Korea, which is hereby incorporated by reference in its entirety.

### BACKGROUND OF THE INVENTION

1. Field of the Invention

This invention relates to a liquid crystal display apparatus integrated with a film type touch panel, and more particularly, to a method of fabricating a liquid crystal display apparatus integrated with a film type touch panel that simplifies its manufacturing process and improves its quality.

2. Discussion of the Related Art

A touch panel is a peripheral device that is installed on a display surface of an image display device, such as cathode ray tube (CRT), liquid crystal display (LCD), field emission display (FED), plasma display panel (PDP) and electro luminescence device (ELD). With the touch panel, a user enters a predetermined instruction to a computer by applying pressure to a portion of the touch panel corresponding to an area of the image display device.

An automated Teller Machine (ATM) is a typical example of a display device integrated with a touch panel as an input device. A voltage or current signal is generated in correspondence with the place on the touch panel pressed with a stylus pen or a finger. A resistive touch panel with an analogue input method is typically used. The resistive touch panel is integrated with a flat panel display, such as a liquid crystal display panel. In general, a liquid crystal display panel controls the light transmittance of the liquid crystal cells interposed between two glass substrates to display an image. Each of the liquid crystal cells responses to a video signal, i.e., a corresponding pixel signal to control the amount of transmitted light.

FIG. 1 illustrates a related art process for fabricating a liquid crystal display device integrated with a touch panel. Referring to FIG. 1, the fabricating method of the liquid crystal display device integrated with the touch panel includes the step of manufacturing LCD cell (S10). The liquid crystal panel is formed through the LCD cell process, which includes the sub-steps of substrate cleaning, substrate patterning, alignment film forming, substrates joining/liquid crystal interposing and mounting processes.

In the substrate cleaning process, impurities on the substrates are eliminated with use of a detergent or cleaning solution both before and after patterning the upper/lower substrate. The substrate patterning process is divided into an upper substrate patterning and a lower substrate patterning. A color filter, a common electrode and a black matrix are formed on the upper substrate. On the lower substrate, there is formed a signal wiring, such as data lines and gate lines, etc. Thin film transistors (TFTs) also are formed on the lower substrate at the intersections of the data lines and the gate lines. Further, pixel electrodes are formed at corresponding pixel areas defined by the data lines and the gate lines and connected to the corresponding source electrodes of the TFTs. In the alignment film forming step, an alignment film is formed on the surface of each substrate.

In the substrates joining/liquid crystal interposing process, after the process of coating and rubbing the alignment film on the upper and lower substrates, the steps of upper/lower substrates joining, liquid crystal injection, and injection hole sealing are sequentially performed with use of a sealant to complete the liquid crystal display panel (Step S10).

Then, after performing a cleaning process S11, a polarizer bonding process S12 is performed on the front and back surfaces of the completed liquid crystal display panel. The polarizers transmit a linearly polarized component of incident light through both sides of the liquid crystal display panel.

After the polarizers are bonded on the front and back surfaces of the liquid crystal display panel having liquid crystal therein, a tape automated bonding (TAB) process (S13) is carried out. In the TAB process, a tape carrier package (TCP) is electrically connected to the lower substrate of the liquid crystal display panel. Also, the TCP may include a driving IC.

Thereafter, the process of printed circuit board (PCB) bonding S14 is carried out, In this process, the PCB is electrically connected to the TCP, which has been connected to gate and data pads in step S13. Thus, through step S14, the gate and data pads are electrically connected to the PCB so that the liquid crystal panel receives driving signals.

Then, the process of backlight assembly S15 is carried out. The backlight assembly process installs, at the back surface of the liquid crystal display module, a light source, a lamp housing for directing light from the light source in a specific direction, a light guide plate and a diffusion sheet for converting the incoming light from the light source into substantially uniform light over a flat area and for directing the light towards the liquid crystal display module, and a reflector for preventing the light from leaking and straying from the light guide plate and the diffusion sheet

After the backlight assembly process, a case assembly process S16 is carried out. The case assembly process forms and assembles a main support for fixing the diffusion sheet and the light guide plate processed in the previous step of PCB bonding S14 and a bottom cover covering the side surface and bottom surface of the main support.

After the case assembly process is carried out an inspection S17 is performed to check whether the liquid crystal display device properly functions. If the device passes the inspection, after cleaning the entire liquid crystal display device at step S18, a touch panel is stuck or bonded onto the liquid crystal display panel (S19).

The touch panel includes an upper sheet and a lower sheet. On the lower sheet, a transparent conductive material is coated on the entire surface. An electrode layer is formed at the edge of the upper and lower sheets, respectively, in different directions. The touch panel further includes an insulation layer not in electrical contact with the electrode layers, a spacer formed between the upper and the lower sheets for separating the sheets by a specific distance therebetween, and a bonding layer formed between the respective electrode layers for bonding the upper sheet and the lower sheet together.

After the touch panel is installed, an inspection S20 is performed to determine whether the resulting touch panel integrated liquid crystal display properly functions. If the device passes the inspection, a top case, which covers the upper edge of the touch panel, is coupled with the bottom cover to complete the manufacture of the touch panel integrated liquid crystal display device.

Therefore, in the fabrication method of the touch panel integrated display device according to the related art technique, an additional process of installing the touch panel is required after fabricating the liquid crystal display module. This increases process costs. Also, due to the additional process, stains and/or impurities can occur at the surface of the liquid crystal display module, thereby deteriorating the display quality of the touch panel integrated liquid crystal display device.

### SUMMARY OF THE INVENTION

Accordingly, it is an object of the present invention to provide a simplified method of fabricating a liquid crystal display apparatus integrated with a film type touch panel.

Another object of the present invention is to provide a film type touch panel integrated liquid crystal display device having a superior display quality.

Additional features and advantages of the invention will be set forth in the description which follows and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention provides a method of fabricating a film type touch panel integrated liquid crystal display apparatus, the method including the steps of forming a liquid crystal display panel that includes gate lines, data lines, and a plurality of liquid crystal cells; cleaning the liquid crystal display panel; attaching a polarizer integrated touch panel to the cleaned liquid crystal display panel, the polarizer integrated touch panel being configured to generate an electrical signal in response to a pressure applied at a portion of the touch panel by an external force; completing a liquid crystal display module by a TAB process in which the liquid crystal display panel is electrically connected to a printed circuit board (PCB) that is configured to apply a driving signal to the liquid crystal display panel; and assembling the liquid crystal display module with a backlight unit.

The method may further include the step of inspecting the resulting film type touch panel integrated liquid crystal display apparatus for its design functions.

The method may further include the step of forming the polarizer integrated touch panel by forming a touch panel on a polarizing sheet before the step of attaching the polarizer integrated touch panel.

In the method described above, the step of forming the polarizer integrated touch panel may include the steps of forming a lower sheet of the touch panel on the polarizing sheet; forming an upper sheet of the touch panel; forming a spacer on the lower sheet of the touch panel that has been formed on the polarizing sheet; and bonding the upper sheet to the lower sheet.

In the method described above, the step of forming the lower sheet of the touch panel may include the steps of forming a first sheet on the polarizer; spreading a lower transparent conductive layer on an entire surface of the first sheet; and forming a first electrode layer at an edge of the lower transparent conductive layer in a first direction for sensing a positional signal in a direction substantially perpendicular to the first direction.

In the method described above, the step of forming the upper sheet of the touch panel may include steps of spreading an upper transparent conductive layer on an entire surface of a sheet; and forming a second electrode layer at an edge of the upper transparent conductive layer in a second direction for sensing a positional signal in a direction substantially perpendicular to the second direction.

In the method described above, the first and the second directions may be made substantially perpendicular to each other.

In the method described above, the upper and the lower sheets may be made of polyethylene terephthalate (PET).

In the method described above, the upper and the lower transparent conductive layers may include at least one of indium-tin-oxide (ITO), indium-zinc-oxide (IZO) and indium-tin-zinc-oxide (ITZO).

The method may further include the step of forming the polarizer integrated touch panel by using a polarizing sheet as a lower sheet of the touch panel before the step of attaching the polarizer integrated touch panel.

In the method described above, the step of forming the polarizer integrated touch panel may include the steps of forming the lower sheet of the touch panel from the polarizing sheet; forming an upper sheet of the touch panel; forming a spacer on the lower sheet of the touch panel; and bonding the upper sheet to the lower sheet.

In the method described above, the step of forming the lower sheet of the touch panel form the polarizing sheet may include the steps of forming a lower transparent conductive layer on an entire surface of the polarizing sheet; and forming a first electrode layer at an edge of the lower transparent conductive layer in a first direction for sensing a positional signal in a direction substantially perpendicular to the first direction.

In the method described above, the step of forming the upper sheet of the touch panel may include the steps of forming an upper transparent conductive layer on an entire surface of a sheet; and forming a second electrode layer at an edge of the upper transparent conductive layer in a second direction for sensing a positional signal in a direction substantially perpendicular to the second direction.

In the method described above, the first and the second directions may be made substantially perpendicular to each other.

In the method described above, the upper and the lower sheets may be made of polyethylene terephthalate (PET).

In the method described above, the upper and the lower transparent conductive layers may include at least one of indium-tin-oxide (ITO), indium-zinc-oxide (IZO) and indium-tin-zinc-oxide (ITZO).

In the method described above, the step of assembling the backlight unit and the liquid crystal display panel may include the step of assembling a light source, a lamp housing, a light guide plate a diffusion sheet, and a reflector into the backlight unit and assembling the resulting backlight unit and the liquid crystal display module into the film type touch panel integrated liquid crystal display apparatus.

The method described above may further include the steps of providing a main support to support the back light unit with respect to the liquid crystal display panel; covering an edge of the main support by a bottom cover; and coupling the bottom cover with a top case to cover an upper surface end of the touch panel and a side surface of the main support.

In the method described above, the polarizer integrated touch panel may be configured such that the external force can be applied by one of a stylus pen or a finger.

It is to be understood that both the foregoing general description and the following detailed description are exemplary and explanatory, and are intended to provide farther explanation of the invention as claimed.

### BRIEF DESCRIPTION OF THE DRAWINGS

The accompanying drawings, which are included to provide a further understanding of the invention and are incorporated in and constitute a part of this application illustrate embodiments of the invention and together with the description serve to explain the principle of the invention. In the drawings:

FIG. 1 represents a related art fabricating process of a touch panel integrated liquid crystal display device;

FIG. 2 is a diagram illustrating a fabricating method of a film type touch panel integrated liquid crystal display device according to an embodiment of the present invention;

FIG. 3 is a side view schematically illustrating a liquid crystal display panel where the steps up to formation of a lower polarizing sheet are carried out;

FIG. 4 is a side view schematically illustrating a polarizer integrated touch panel installed onto the liquid crystal display panel of FIG. 3;

FIG. 5 is a cross-sectional view of the touch panel integrated liquid crystal panel of FIG. 4; and

FIG. 6 is a side view schematically illustrating a touch panel integrated liquid crystal display module of FIG. 4 having a tape carrier package (TCP) and a printed circuit board (PCB) installed thereon.

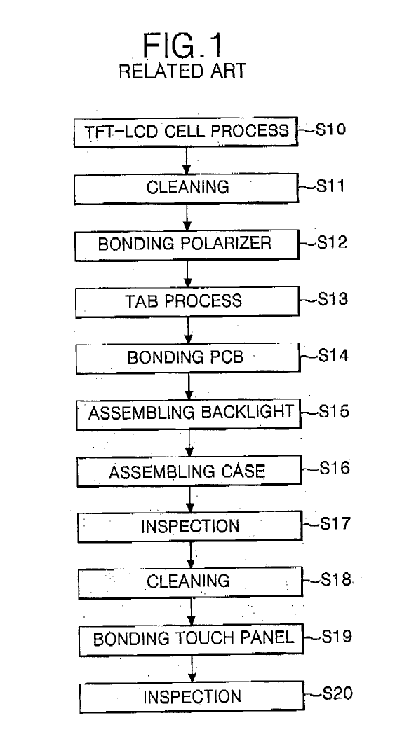

### DETAILED DESCRIPTION OF THE PREFERRED EMBODIMENT

Reference will now be made in detail to the embodiments of the present invention, examples of which are illustrated in the accompanying drawings.

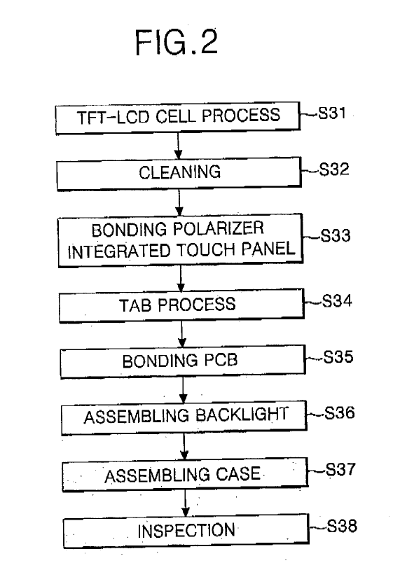

Referring to FIG. 2, a fabricating method of a touch panel integrated liquid crystal display device according to this example includes an LCD cell process S31 in which the liquid crystal panel is formed. In this example, an active matrix driving type LCD is formed and the LCD cell process includes the sub-steps of substrate cleaning, substrate patterning, alignment film forming, substrates joining/liquid crystal interposing and mounting.

In the substrate cleaning process, impurities on the substrate are eliminated using a detergent or cleaning solution both before and after patterning the upper and lower substrates for the liquid crystal display panel. The substrate patterning process is divided into upper substrate patterning and lower substrate patterning A color filter, a common electrode and a black matrix are formed on the upper substrate. On the lower substrate, there is formed a signal wiring such as data lines and gate lines, etc. Also on the lower substrate, thin film transistors (TFTs) are formed at the intersections of the data lines and the gate lines, and pixel electrodes are formed at pixel areas defined by the data lines and the gate lines and are connected to the corresponding source electrodes of the TFTs. Subsequently, the alignment films are formed on the lower and upper substrate, respectively

In the substrates joining/liquid crystal interposing process, after the process of spreading and rubbing the alignment film on the lower substrate, the steps of upper/lower substrate joining, liquid crystal injection, and injection hole sealing are sequentially carried out with use of a sealant to complete the manufacture of the liquid crystal display panel.

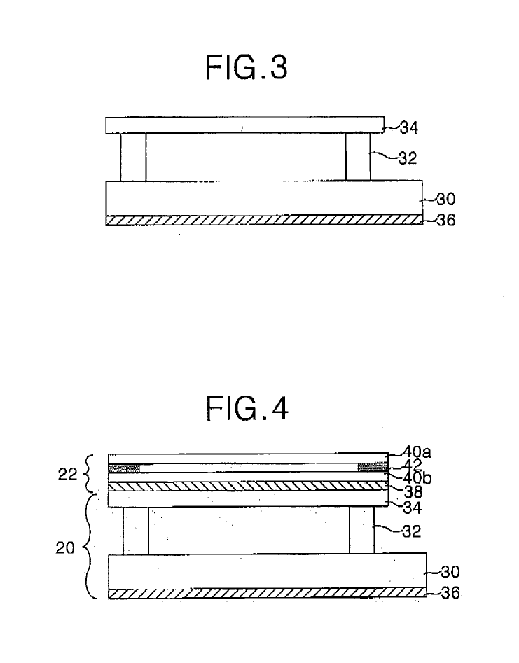

An example of the liquid crystal display panel formed through the above-mentioned processes is schematically illustrated in FIG. 3. An upper substrate 34 and a lower substrate 30 are coupled at the outer edge areas via a sealant to form the liquid crystal display panel. Also, a lower polarizing sheet 36 is formed at the back surface of the liquid crystal display panel.

Then, after carrying out a cleaning process S32 of FIG. 2, in step S33, a polarizer integrated touch panel is bonded onto the liquid crystal panel formed through the LCD cell process of S31. Here, the bonded polarizer integrated touch panel is formed by forming functional elements of the touch panel on a polarizing sheet or by replacing the lower sheet of the touch panel with a polarizing sheet.

The case of forming functional elements of the touch panel on a polarizing sheet will be explained. In this case, the polarizing sheet on which the functional elements of the touch panel are formed functions as the upper polarizing sheet of the liquid crystal display device. A lower sheet of the touch panel is formed on the polarizing sheet. On the lower sheet of the touch panel, a lower transparent conductive layer is spread on the entire surface, and a first electrode layer is formed at the edge of the lower transparent conductive layer for sensing a positioning signal in a specified direction, such as the Y-axis direction.

The upper portion of the touch panel includes an upper sheet an upper transparent conductive layer spread on the entire surface of the upper sheet, a second electrode layer formed at the edge of the upper transparent conductive layer for sensing a positioning signal in a direction different from the direction of the first electrode layer, such as the X-axis direction. The touch panel further includes a bonding layer for bonding the upper sheet and the lower sheet together, an insulating layer for electrical insulation between the electrode layers at the edge of the upper and lower sheets. Also, it includes a spacer for separating the upper sheet from the lower sheet by a specific distance therebetween.

In this example, the upper sheet and the lower sheet may preferably be formed of a polyethylene terephthalate (PET) film, and the upper and the lower transparent conductive layer are formed of a transparent conductive material, such as indium-tin-oxide (ITO) or indium-tin-zinc-oxide (ITZO), for example. A silver (Ag) paste is printed to form the first and the second electrode layers, for example.

Next, the case of forming the touch panel by replacing only the lower sheet of the touch panel with a polarizing sheet will be explained. The lower portion of the touch panel includes a polarizing sheet as the lower sheet of the touch panel, a lower transparent conductive layer spread on the entire surface of the polarizing sheet, and a first electrode layer formed on the lower transparent conductive layer for sensing the positioning signal in a first direction, such as the Y-axis direction.

The upper portion of the touch panel includes an upper sheet, an upper transparent conductive layer spread on the entire surface of the upper sheet, a second electrode layer formed at the edge of the upper transparent conductive layer for sensing a positioning signal in a second direction different from the first direction, such as the X-axis direction. The touch panel of this example further includes a bonding layer for bonding the upper sheet and the lower sheet together, an insulating layer for electrical insulation between the electrode layers at the edge of the upper and lower sheets. The touch panel also includes a spacer for separating the upper plate from the lower plate by a specific distance therebetween.

In this example, the upper and lower sheets may preferably be formed of a polyethylene terephthalate (PET) film, and the upper and the lower transparent conductive layers may preferably be formed of a transparent conductive material, such as indium-tin-oxide (ITO) or indium-tin-zinc-oxide (ITZO), for example. A silver (Ag) paste is printed to form the first and the second electrode layers, for example.

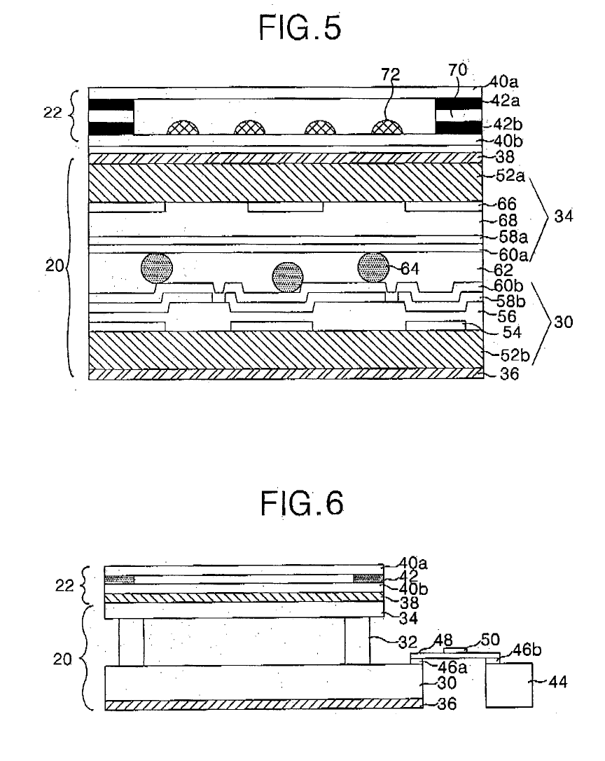

FIG. 4 is a side view schematically showing a liquid crystal display panel having a polarizer integrated touch panel installed thereon. FIG. 5 is a cross-sectional view of the touch panel integrated liquid crystal display panel of FIG. 4.

Referring to FIGS. 4 and 5, the touch panel integrated liquid crystal display panel includes a liquid crystal panel 20 and a touch panel 22. Liquid crystal cells are located between an upper polarizing sheet 38 and a lower polarizing sheet 36, and the touch panel 22 is mounted on the upper polarizing sheet 38. The liquid crystal display panel 20 includes ball spacers 64 and a liquid crystal material 62, which is interposed between a lower glass substrate 52B and an upper glass substrate 52a. Gate lines 54, an insulation film 56, pixel electrodes 58b and a first alignment film 60b are sequentially formed on the lower glass substrate 52b. The upper glass substrate 52a includes a black matrix 66, a color filter 68, a common electrode 58a and a second alignment film 60a sequentially formed on its lower surface. The ball spacers 64 are sprayed on the first alignment film 60b before the upper glass substrate 52a and the lower substrate 52b are bonded together. The ball spacers 64 separate the upper and lower glass substrates 52a and 52b to maintain a specific distance therebetween. In other words, the ball spacers 64 uniformly maintains the distance between the upper and the lower glass substrates 52a and 52b to yield a uniform thickness of the liquid crystal material 62.

The touch panel 22 has spacers 72 sprayed between the upper sheet 40a and the lower sheet 40b made of a PET film. A first electrode layer 42a is formed on the bottom surface of the upper substrate 40a, and a second electrode layer 42b is formed on the top surface of the lower sheet 40b. When a designated portion of the upper sheet 40a is pressed with a stylus pen or a finger, the corresponding first electrode layer 42a makes electrical contact with the second electrode layer 42b to generate a signal, which has a different amount of electric current or voltage level depending on the position of the user interaction. Silver (Ag) is printed on a transparent conductive layer made of ITO, IZO (Indium-Zinc-Oxide) or ITZO, for example, in forming the first and the second electrode layers 42a and 42b.

After the polarizer integrated touch panel is bonded on the liquid crystal panel 20, a TAB process S34, as described in FIG. 2, is carried out on the liquid crystal display panel. In the TAB process, a tape carrier package (TCP) is formed and electrically connected to the lower substrate of the liquid crystal display panel 20. A driving IC may be mounted on the TCP.

After the TAB process is completed, a process of connecting the TCP to a printed circuit board (PCB) is carried out, as shown in FIG. 6 (S35 in FIG. 2). This process electrically connects the gate and data pads of the liquid crystal display panel 20 to the PCB for applying driving signals.

Referring to FIG. 6, TCP 48 is connected to the touch panel integrated liquid crystal display device and to PCB 44 via contacts 46a and 46b, respectively. Preferably, the TCP includes a drive IC 50 mounted thereon. Thus, in FIG. 6, the touch panel integrated liquid crystal display panel of FIG. 4 is connected to the PCB 44 via TCP 48.

Then, a backlight assembly process is carried out (S36 in SIG. 2). The backlight assembly process forms a light source on the lower surface of the liquid crystal display module manufactured through the above processes, a lamp housing for directing light from the light source in a specific direction, a light guide plate and a diffusion sheet for converting incoming light into a substantially uniform light over a flat area and directing the light towards the liquid crystal display module, and a reflector for preventing light from leaking and straying from the light guide plate and the diffusion sheet.

After the backlight assembly process (S36), a case assembly step (S37) is carried out. The case assembly process forms and assembles a main support for fixing the diffusion sheet and the light guide plate formed in the previous step (S36) and a bottom cover covering the side surface and bottom surface of the main support.

After the case assembly step is carried out, an inspection (S38) is performed to determine whether the resulting liquid crystal display device properly functions. If the device passes the inspection, a top case that covers the upper edge of the touch panel is coupled with the bottom cover to complete the manufacture of the touch panel integrated liquid crystal display device.

As described above, the fabricating method of the touch panel integrated liquid crystal display device according to the above examples installs a polarizer integrated touch panel after completing the liquid crystal display panel at a stage of the manufacturing process where an upper polarizing sheet bonding process would be carried out in the related art. Thus, the method according to the examples of the present invention does not require an additional step of bonding the touch panel after the liquid crystal display device is completed and after other processes, such as TAB, PCB processes, are carried out Thus, according to the examples of the present invention, a touch panel integrated liquid crystal display device is fabricated without additional processes. Consequently, the process becomes simplified and fabricating costs are reduced. Furthermore, the display quality is improved owing to the lessened possibility of impurity contamination.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of fabricating a film type touch panel integrated liquid crystal display apparatus, the method comprising the steps of:
forming a liquid crystal display panel that includes gate lines, data Lines, and a plurality of liquid crystal cells;
cleaning the liquid crystal display panel;
attaching a polarizer integrated touch panel to the cleaned liquid crystal display panel, the polarizer integrated touch panel being configured to generate an electrical signal in response to a pressure applied at a portion of the touch panel by an external force;
completing a liquid crystal display module by a TAB process in which the liquid crystal display panel is electrically connected to a printed circuit board (PCB) that is configured to apply a driving signal to the liquid crystal display panel; and
assembling the liquid crystal display module with a backlight unit.

2. The method according to claim 1, further includes the step of:
inspecting the resulting film type touch panel integrated liquid crystal display apparatus for its design functions.

3. The method according to claim 1, further including the step of forming the polarizer integrated touch panel by forming a touch panel on a polarizing sheet before the step of attaching the polarizer integrated touch panel.

4. The method according to claim 3, wherein the step of forming the polarizer integrated touch panel includes the steps of:
forming a lower sheet of the touch panel on the polarizing sheet;
forming an upper sheet of the touch panel;
forming a spacer on the lower sheet of the touch panel that has been formed on the polarizing sheet; and
bonding the upper sheet to the lower sheet.

5. The method according to claim 4, wherein the step of forming the lower sheet of the touch panel includes the steps of:
forming a first sheet on the polarizer;
spreading a lower transparent conductive layer on an entire surface of the first sheet; and
forming a first electrode layer at an edge of the lower transparent conductive layer in a first direction for sensing a positional signal in a direction substantially perpendicular to the first direction.

6. The method according to claim 5, wherein the step of forming the upper sheet of the touch panel includes steps of:
spreading an upper transparent conductive layer on an entire surface of a sheet; and
forming a second electrode layer at an edge of the upper transparent conductive layer in a second direction for sensing a positional signal in a direction substantially perpendicular to the second direction.

7. The method according to claim 6, wherein the first and the second directions are substantially perpendicular to each other.

8. The method according to claim 6, wherein the upper and the lower sheets are made of polyethylene terephthalate (PET).

9. The method according to claim 6, wherein the upper and the lower transparent conductive layers include at least one of indium-tin-oxide (ITO), indium-zinc-oxide (IZO) and indium-tin-zinc-oxide (ITZO).

10. The method according to claim 1, further including the step of forming the polarizer integrated touch panel by using a polarizing sheet as a lower sheet of the touch panel before the step of attaching the polarizer integrated touch panel.

11. The method according to claim 10, wherein the step of forming the polarizer integrated touch panel includes the steps of:
forming the lower sheet of the touch panel from the polarizing sheet;
forming an upper sheet of the touch panel;
forming a spacer on the lower sheet of the touch panel, and bonding the upper sheet to the lower sheet.

12. The method according to claim 1, wherein the step of forming the lower sheet of the touch panel form the polarizing sheet includes the steps of:
forming a lower transparent conductive layer on an entire surface of the polarizing sheet; and
forming a first electrode layer at an edge of the lower transparent conductive layer in a first direction for sensing a positional signal in a direction substantially perpendicular to the first direction.

13. The method according to claim 12, wherein the step of forming the upper sheet of the touch panel includes the steps of:
forming an upper transparent conductive layer on an entire surface of a sheet; and
forming a second electrode layer at an edge of the upper transparent conductive layer in a second direction for sensing a positional signal in a direction substantially perpendicular to the second direction.

14. The method according to claim 13, wherein the first and the second directions are substantially perpendicular to each other.

15. The method according to claim 13, wherein the upper and the lower sheets are made of polyethylene terephthalate (PET).

16. The method according to claim 13, wherein the upper and the lower transparent conductive layers include at least one of indium-tin-oxide (ITO), indium-zinc-oxide (IZO) and indium-tin-zinc-oxide (ITZO).

17. The method according to claim 1, wherein the step of assembling the backlight unit and the liquid crystal display panel includes the step of assembling a light source, a lamp housing, a light guide plate a diffusion sheet, and a reflector into the backlight unit and assembling the resulting backlight unit and the liquid crystal display module into the film type touch panel integrated liquid crystal display apparatus.

18. The method according to claim 1, further comprising the steps of:
providing a main support to support the back light unit with respect to the liquid crystal display panel;
covering an edge of the main support by a bottom cover; and
coupling the bottom cover with a top case to cover an upper surface end of the touch panel and a side surface of the main support.

19. The method according to claim 1, wherein the polarizer integrated touch panel is configured such that the external force can be applied by one of a stylus pen or a finger.

20. A method of fabricating a touch panel integrated liquid crystal display apparatus, the method comprising the steps of:
forming a liquid crystal display panel;
attaching a polarizer integrated touch panel to the liquid crystal display panel, the polarizer integrated touch panel being configured to generate an electrical signal in response to a pressure applied at a portion of the touch panel by an external force; and
attaching a printed circuit board to the liquid crystal display having the polarizer integrated touch panel attached thereto.
